(19) United States
(12) Patent Application Publication
(10) Pub. No.: US 2025/0224574 A1
(43) Pub. Date: Jul. 10, 2025

(54) ATHERMAL PLASTIC COUPLER

(71) Applicant: Lumentum Operations LLC, San Jose, CA (US)

(72) Inventors: Sergei EVLADOV, Waterloo (CA); Raman SRINIVASAN, Fremont, CA (US)

(21) Appl. No.: 18/615,030

(22) Filed: Mar. 25, 2024

Related U.S. Application Data
(60) Provisional application No. 63/618,728, filed on Jan. 8, 2024.

(51) Int. Cl. G02B 6/42

(52) U.S. Cl. CPC G02B 6/4214

(57) ABSTRACT

An athermal optical coupler assembly includes a light collector optical component configured to receive a light beam and convert the light beam into a collected light beam; and a coupling optical component configured to receive the collected light beam from the light collector optical component and focus the collected light beam onto a target area irrespective of an ambient temperature within a predetermined temperature range. The light collector optical component includes a first body having a one-piece integral construction made of a first molded plastic, a first optically reflective surface arranged on the first body, and a second optically reflective surface arranged on the first body. The coupling optical component includes a second body having a one-piece integral construction made of a second molded plastic, a third optically reflective surface arranged on the second body, and a fourth optically reflective surface arranged on the second body.

### CROSS-REFERENCE TO RELATED APPLICATION

This Patent Application claims priority to U.S. Patent Application No. 63/618,728, filed on Jan. 8, 2024, and entitled “ATHERMAL PLASTIC COUPLER.” The disclosure of the prior Application is considered part of and is incorporated by reference into this Patent Application.

### TECHNICAL FIELD

The present disclosure relates generally to optical couplers.

### BACKGROUND

A typical thermally-tuned narrow linewidth laser semiconductor optical amplifier (TTNL-SOA) coupler is made of silicon refractive lenses, including a collimating lens and a coupling lens. A high refractive index (n) of silicon helps with aberrations management due to more relaxed radii of curvature. Additionally, silicon has a relatively low thermal coefficient of expansion (TCE) that helps to prevent large deformations of an optical element during temperature shifts, thus reducing insertion loss temperature sensitivity. On the other hand, silicon is a relatively expensive material.

### SUMMARY

In some implementations, an athermal optical coupler assembly includes a light collector optical component configured to receive a light beam and convert the light beam into a collected light beam; and a coupling optical component optically coupled to the light collector optical component, wherein the coupling optical component is configured to receive the collected light beam from the light collector optical component and focus the collected light beam onto a target area, wherein the light collector optical component includes a first body having a one-piece integral construction made of a first molded plastic, a first optically reflective surface arranged on the first body, and a second optically reflective surface arranged on the first body, wherein the coupling optical component includes a second body having a one-piece integral construction made of a second molded plastic, a third optically reflective surface arranged on the second body, and a fourth optically reflective surface arranged on the second body, wherein the second optically reflective surface is optically coupled between the first optically reflective surface and the third optically reflective surface, wherein the third optically reflective surface is optically coupled between the second optically reflective surface and the fourth optically reflective surface, and wherein the athermal optical coupler assembly is configured to maintain a projection of the collected light beam via the coupling optical component at the target area irrespective of an ambient temperature within a predetermined temperature range.

### BRIEF DESCRIPTION OF THE DRAWINGS

FIGS. 1A and 1B show an athermal optical coupler assembly according to one or more implementations.

FIGS. 2A and 2B show a light collector optical component according to one or more implementations.

### DETAILED DESCRIPTION

The following detailed description of example implementations refers to the accompanying drawings. The same reference numbers in different drawings may identify the same or similar elements.

A conventional TTNL-SOA coupling system may include a laser source (e.g., a TTNL), two coupling lenses (e.g., a collector lens and a coupling lens), and an SOA. The collector lens may receive a laser beam from the laser source and provide a laser beam that is directed toward the coupling lens. The coupling lens may be a focusing lens that directs (e.g., focuses) the collimated laser beam into an input waveguide of the SOA. Both coupling lenses may be silicon refractive lenses.

An optical axis of the conventional TTNL-SOA coupling system may be shifted with respect to a nominal axis (e.g., a desired nominal optical path) with an increase in temperature due to deformation of the collector lens and/or the coupling lens due to thermal expansion. In some cases, the optical axis may be shifted with respect to the nominal axis due to a deformation of one or more mounting structures on which the conventional TTNL-SOA coupling system is mounted. In some cases, the collector lens and the coupling lens may change by differing amounts, which may contribute to the shift from the nominal axis. The shift of the optical axis from the nominal axis may lead to an image dislocation from an intended position, and thus to coupling loss. In other words, the collimated laser beam may be shifted at least partially away from the input waveguide of the SOA, which may cause a coupling loss to increase beyond a coupling loss that may be considered acceptable. Thus, a temperature shift may cause a light path to be shifted away from a desired optical axis at the SOA side.

Some implementations described herein provide a lens coupling system that may be used as a waveguide/fiber to waveguide/fiber coupler. The lens coupling system may include a light collector optical component (e.g., a collimating lens) and a coupling optical component (e.g., a coupling lens). The light collector optical component may be optically coupled to a transmission component for receiving a light beam, such as a laser beam, from the transmission component. The transmission component may be an optical output, a light source, a waveguide, or an optical fiber. In some implementations, the transmission component may be a TTNL laser. The light collector optical component may be optically coupled to the coupling optical component for providing a collimated beam to the coupling optical component. The coupling optical component may be optically coupled to a receiving component for providing a focused light beam at a desired target location or target area of the receiving component, with the desired target location being located on a desired optical axis. The receiving component may be an optical input, a waveguide, and/or an optical fiber. In some implementations, the receiving component may be an input waveguide of an SOA.

The lens coupling system may have a low coupling loss over a wide range of operating temperatures. For example, a range of operating temperatures may be 20-40 degrees Celsius. However, the range of operating temperatures may be configurable based on a design of the lens coupling system. Thus, the range of operating temperatures may include a different range of temperatures, including a broader range of temperatures, a narrower range of temperatures, or a different range of temperatures, including lower temperatures and/or higher temperatures. The lens coupling system may include two molded plastic components that reshape, collimate, and couple a light beam from an optical source to an optical target. For example, the light collector optical component may be a first molded plastic component of the two molded plastic components, and the coupling optical component may be a second molded plastic component of the two molded plastic components. Despite the two molded plastic components being made of plastic, which has a high TCE (e.g., higher than a TCE of silicon), the lens coupling system may operate on par with a lens coupling system that is made of low TCE materials, such as silicon. Moreover, the two molded plastic components are capable of maintaining high performance at a lower material cost than silicon-based coupling systems. Plastic may include, but may not be limited to, Zeonex® or Ultem®.

The lens coupling system provides an athermal optical system that is substantially insensitive to temperature changes within the range of operating temperatures while using relatively inexpensive plastic optical components. The lens coupling system may be used as a waveguide coupler, an optical fiber coupler, or an optical coupler arranged between any two optical components for coupling light from one optical component to another optical component. The lens coupling system may provide a coupling between any pair of waveguide components.

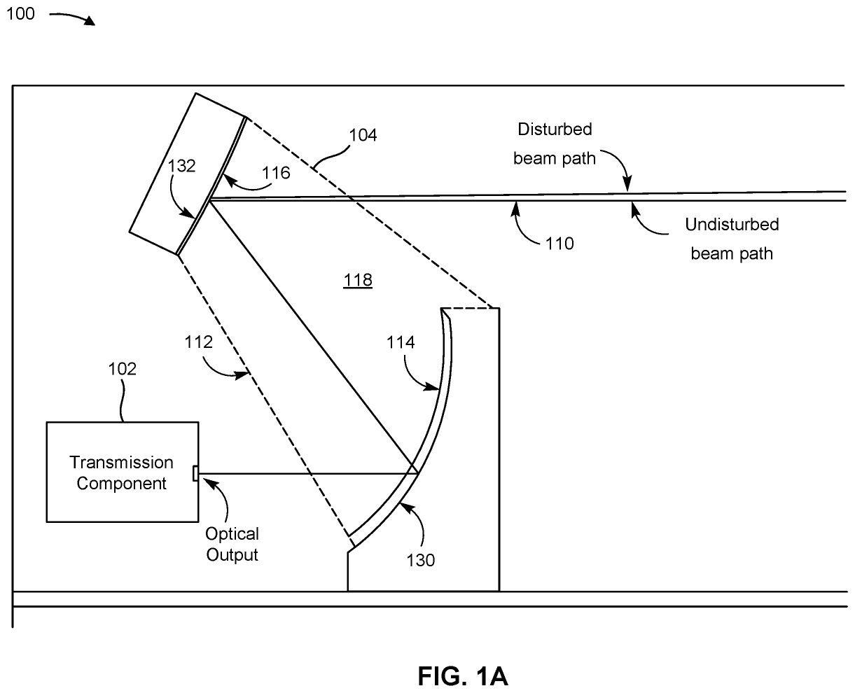

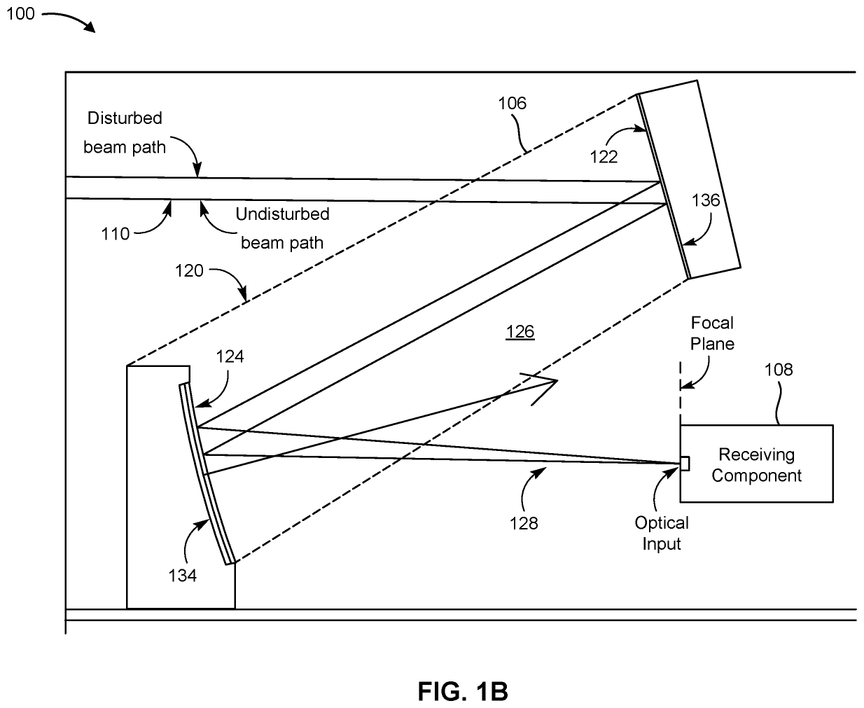

FIGS. 1A and 1B show an athermal optical coupler assembly 100 according to one or more implementations. FIG. 1A shows a transmission side of the athermal optical coupler assembly 100, including a transmission component 102 and a light collector optical component 104. In some implementations, the light collector optical component 104 may be a collimating optical component. FIG. 1B shows a receiver side of the athermal optical coupler assembly 100, including a coupling optical component 106 and a receiving component 108. Thus, the light collector optical component 104 and the coupling optical component 106 may be configured to optically couple a light beam from an optical output of the transmission component into an optical input of the receiving component.

The transmission component 102 may be an optical output of an optical component, a light source, an optical waveguide, or an optical fiber. The receiving component 108 may be an optical input of an optical component, an optical waveguide, and/or an optical fiber. In some implementations, the transmission component 102 may be an optical source, such as a laser source, or another type of transmitting optical component. The receiving component 108 may be an input waveguide of an SOA, or another type of receiving optical component. The optical input of the receiving component 108 may correspond to a target area (e.g., a coupling area) at which the light beam is to be directed with minimal insertion loss and/or minimal change to insertion loss when the athermal optical coupler assembly 100 is exposed to a shift in ambient temperature. The target area may be an input area of an optical waveguide or an area of a fiber core of an optical fiber. In some implementations, it may be desired to target the light beam at a center of the target area (e.g., at a center of the optical waveguide or at a center of the fiber core) and minimize a shift of the light beam away from the center of the target area irrespective of temperature shifts in ambient temperature within a predetermined temperature range, such as 20-40 degrees Celsius.

The light collector optical component 104 and the coupling optical component 106 may be molded plastic components made of an optical plastic. The athermal optical coupler assembly 100 may include four optically reflective surfaces, thus minimizing or eliminating a refractive index temperature dependence (dn/dT=0). The light collector optical component 104 may include a first pair (e.g., a first two) of the four optically reflective surfaces, and the coupling optical component 106 may include a second pair (e.g., a second two) of the four optically reflective surfaces. The four optically reflective surfaces may be made out of a metal coatings (e.g., aluminum, gold), or the four reflective surfaces may be dielectric coatings.

A geometrical arrangement of the light collector optical component 104 and the coupling optical component 106, namely the four optically reflective surfaces, operates as a temperature compensator for temperature-induced deformations and temperature-induced movements of the light collector optical component 104 and the coupling optical component 106. Thus, the geometrical arrangement makes the coupling system athermal in the temperature range of interest, such as 20-40 degrees Celsius.

An undisturbed beam path may correspond to a nominal optical path along which a light beam may travel when there is no disturbance caused by ambient temperature. A disturbed beam path may correspond to a shifted optical path along which a light beam may travel when there is a disturbance caused by a shift in ambient temperature. The athermal optical coupler assembly 100 may be configured in such a way that a light beam is incident on a target area of the receiving component 108 with minimal insertion loss and/or minimal change to insertion loss irrespective of whether the light beam travels on the undisturbed beam path on a disturbed beam path. In other words, the athermal optical coupler assembly 100 may be configured in such a way that the light beam is incident on the target area of the receiving component 108 with minimal insertion loss and/or minimal change to insertion loss irrespective of the ambient temperature within the predetermined temperature range.

As shown in FIG. 1A, the light collector optical component 104 may be configured to receive the light beam from the transmission component 102 and convert the light beam into a collected light beam 110. In some implementations, the collected light beam 110 may be a collimated light beam. The light collector optical component 104 may include a first body 112 having a one-piece integral construction made of a first molded plastic, a first optically reflective surface 114 arranged on the first body 112, and a second optically reflective surface 116 arranged on the first body 112. The first body 112 may define a first cavity 118 through which the light beam travels from the first optically reflective surface 114 to the second optically reflective surface 116. Thus, the first cavity 118 may be a first hollow passage. The first cavity 118 may be defined, at least in part, by sidewalls of the first body 112.

Thus, the light collector optical component 104 is a first sub-assembly that may include two optically reflective surfaces, including the first optically reflective surface 114 and the second optically reflective surface 116. The first optically reflective surface 114 may receive the light beam and direct the light beam at the second optically reflective surface 116. The second optically reflective surface 116 may receive the light beam and direct the light beam at the coupling optical component 106.

As shown in FIG. 1B, the coupling optical component 106 includes a second body 120 having a one-piece integral construction made of a second molded plastic, a third optically reflective surface 122 arranged on the second body 120, and a fourth optically reflective surface 124 arranged on the second body 120. The second body 120 may define a second cavity 126 through which the collected light beam 110 travels from the third optically reflective surface 122 to the fourth optically reflective surface 124. Thus, the second cavity 126 may be a second hollow passage. The second cavity 126 may be defined, at least in part, by sidewalls of the second body 120.

Thus, the coupling optical component 106 is a second sub-assembly that may include two optically reflective surfaces, including the third optically reflective surface 122 and the fourth optically reflective surface 124. The third optically reflective surface 122 may receive the light beam from the light collector optical component 104 (e.g., from the second optically reflective surface 116) and direct the light beam at the fourth optically reflective surface 124. The fourth optically reflective surface 124 may receive the light beam and direct the light beam at a desired target location of an optical target. Thus, the second optically reflective surface 116 is optically coupled between the first optically reflective surface 114 and the third optically reflective surface 122. Moreover, the third optically reflective surface 122 is optically coupled between the second optically reflective surface 116 and the fourth optically reflective surface 124.

Each sub-assembly is a one-piece molded plastic part (e.g., one-piece integral structure of a single member construction) with two optically reflective surfaces. The optically reflective surfaces may be formed on the one-piece molded plastic part as reflective coatings. The athermal optical coupler assembly 100 may be configured to maintain a projection of the collected light beam 110 via the coupling optical component 106 at the target area irrespective of the ambient temperature within the predetermined temperature range. In other words, the athermal optical coupler assembly 100 may be substantially insensitive to a temperature change of ambient temperature within the predetermined temperature range. For example, the coupling optical component 106 may focus a beam center of the collected light beam 110 within a predetermined distance from a center of the target area (e.g., a center of the optical input) irrespective of the ambient temperature within the predetermined temperature range. As a result, an acceptable portion of the light beam may be coupled into the receiving component 108 irrespective of the ambient temperature within the predetermined temperature range. In other words, any insertion loss may be minimized while the ambient temperature is within the predetermined temperature range.

As shown in FIG. 1B, the coupling optical component 106 may convert the collected light beam 110 into a focused light beam 128 that is focused onto the target area irrespective of the ambient temperature within the predetermined temperature range. The target area may be located at a focal plane of the fourth optically reflective surface 124.

As noted above, the light collector optical component 104 may be optically coupled to the optical output of the transmission component 102 for receiving the light beam from the transmission component 102, and the coupling optical component 106 may be optically coupled to the optical input of the receiving component 108. The optical input may be arranged at the target area such that the collected light beam 110 is coupled into the optical input. In some implementations, the transmission component 102 may include a first optical waveguide or a first optical fiber optically coupled to the light collector optical component 104 for providing the light beam to the light collector optical component 104. Additionally, or alternatively, the receiving component 108 may include a second optical waveguide or a second optical fiber coupled to and arranged at the optical input.

In some implementations, the light collector optical component 104 may be configured to reshape a cross-section of the light beam from a first beam profile into a second beam profile to conform to a cross-section of the second optical waveguide or the second optical fiber. Thus, the collected light beam 110 may have the second beam profile. For example, when the transmission component 102 is a laser source, the first beam profile may have an elliptical beam profile, whereas the second optical waveguide or the second optical fiber may have a circular profile. Thus, the light collector optical component 104 may be configured to reshape a cross-section of the light beam from the elliptical beam profile into a circular beam profile. In another example, a diameter of the first optical waveguide or the first optical fiber may be different from a diameter of the second optical waveguide or the second optical fiber. Thus, the light collector optical component 104 may be configured to reshape a cross-section of the light beam from a first beam diameter into a second beam diameter. In some implementations, the first beam profile has a first aspect ratio, and the second beam profile has a second aspect ratio that is different from the first aspect ratio. In some implementations, the light collector optical component 104 may be configured to rotate an axis of the light beam received from the transmission component 102 to produce the collected light beam 110 with a rotated axis.

In some implementations, the coupling optical component 106 may be configured to reshape a cross-section of the collected light beam 110 from a first beam profile into a second beam profile to conform to a cross-section of the second optical waveguide or the second optical fiber. Thus, the collected light beam 110 may have the first beam profile and the focused light beam 128 may have the second profile. For example, when the transmission component 102 is a laser source, the first beam profile may have an elliptical beam profile, whereas the second optical waveguide or the second optical fiber may have a circular profile. Thus, the coupling optical component 106 may be configured to reshape a cross-section of the collected light beam 110 from the elliptical beam profile into a circular beam profile. In another example, a diameter of the first optical waveguide or the first optical fiber may be different from a diameter of the second optical waveguide or the second optical fiber. Thus, the coupling optical component 106 may be configured to reshape a cross-section of the collected light beam 110 from a first beam diameter into a second beam diameter. In some implementations, the first beam profile has a first aspect ratio, and the second beam profile has a second aspect ratio that is different from the first aspect ratio. In some implementations, the coupling optical component 106 may be configured to convert the collected light beam 110 into the focused light beam 128 by rotating an axis of the collected light beam 110 such that the focused light beam 128 has a rotated axis relative to the collected light beam 110.

In some implementations, the light collector optical component 104 and the coupling optical component 106 may be operatively coupled to convert the light beam provided by the transmission component 102 from the first beam profile into the second beam profile to conform to the cross-section of the second optical waveguide or the second optical fiber. Thus, the focused light beam 128 may have the second beam profile and the collected light beam 110 may have an intermediate beam profile (e.g., a third beam profile) that represents intermediate transformation between the first beam profile and the second beam profile.

The coupling optical component 106 may be configured to convert a spatial offset of the collected light beam 110 resultant from a temperature change of ambient temperature into an angular offset at the target area of the optical input at the receiving component. In some implementations, the fourth optically reflective surface 124 or a combination of the third optically reflective surface 122 and the fourth optically reflective surface 124 may convert the spatial offset resultant from the temperature change of ambient temperature into the angular offset at the target area such that the collected light beam 110 is focused on the target area with the angular offset. For example, the disturbed path of the collected light beam 110 may have a spatial offset from the undisturbed path as a result of the temperature change. In other words, the spatial offset may be a deviation from a nominal optical path between the light collector optical component 104 and the coupling optical component 106. The coupling optical component 106 may convert the spatial offset into the angular offset at the target area of the optical input such that the collected light beam 110 (e.g., the focused light beam 128) is maintained at the target area with no or minimal spatial shift. Instead, an axis (e.g., a radial axis or a major axis) of the collected light beam 110 may have an angular offset (e.g., angular shift or angular rotation) at the target area relative to an angular profile of the collected light beam 110 upstream from the coupling optical component 106. Thus, the coupling optical component 106 may compensate for the spatial offset to in order to maintain the collected light beam 110 at the target area with no to minimal change in insertion loss by converting the spatial shift into the angular offset. In some implementations, the spatial offset may be reduced or eliminated by the coupling optical component 106 by some other means of compensation.

In some implementations, the light collector optical component 104 may be used in combination with the coupling optical component 106 to convert a spatial offset of the light beam resultant from the temperature change of ambient temperature into the angular offset at the target area of the optical input at the receiving component. For example, the spatial offset may be present, at least in part, upstream from the light collector optical component 104. Additionally, or alternatively, the spatial offset may be present, at least in part between the first optically reflective surface 114 and the second optically reflective surface 116. Thus, the second optically reflective surface 116 may convert at least some of the spatial offset into at least a portion of the angular offset.

In some implementations, the first body 112 of the light collector optical component 104 has a surface 130 that is a first concave surface, and a surface 132 that is a convex surface. The first optically reflective surface 114 may be arranged on the surface 130 (e.g., the first concave surface) and may conform to the surface 130. In some implementations, the surface 130 may be aspherical. For example, the surface 130 may be parabolic. Thus, the first optically reflective surface 114 may reduce or eliminate spherical aberration. The second optically reflective surface 116 may be arranged on the surface 132 (e.g., the convex surface) and may conform to the surface 132. The first optically reflective surface 114 and the second optically reflective surface 116, in combination, may produce no spherical aberrations.

In addition, the second body 120 of the coupling optical component 106 may have a surface 134 that is a second concave surface, and a surface 136 that may be flat, concave, or convex. In the example shown in FIG. 1B, the surface 136 is a flat surface. The fourth optically reflective surface 124 may be arranged on the surface 134 (e.g., the second concave surface) and may conform to the surface 134. In some implementations, the surface 134 may be aspherical. For example, the surface 134 may be parabolic. Thus, the fourth optically reflective surface 124 may reduce or eliminate spherical aberration. The third optically reflective surface 122 may be arranged on the surface 136 (e.g., the flat surface) and may conform to the surface 136. The third optically reflective surface 122 and the fourth optically reflective surface 124, in combination, may produce no spherical aberrations. In some implementations, a surface profile of the surface 136 may be configured to compensate for an aberration produced by the light collector optical component 104. For example, the surface 136 may be concave, convex, and/or aspherical such that the third optically reflective surface 122 at least partially compensates for an aberration produced by the light collector optical component 104.

Thus, the light collector optical component 104 and the coupling optical component 106 may be cooperatively coupled in a way that compensates for changes in ambient temperatures that would otherwise cause the collected light beam 110 (e.g., the focused light beam 128) to shift away from the target area of the optical input and cause insertion loss to exceed an acceptable level. As a result, the athermal optical coupler assembly 100 may be substantially insensitive to temperature changes of the ambient temperature within the predetermined temperature range. Moreover, the athermal optical coupler assembly 100 may provide a reduction in cost compared to a coupling system that uses silicon or other low TCE materials. Since the light collector optical component 104 and the coupling optical component 106 are molded from a plastic material, a cost of the light collector optical component 104 and the coupling optical component 106 may be considered negligible when produced in large quantities. Furthermore, due to the ease of molding plastic, the optical surfaces of the light collector optical component 104 and the coupling optical component 106 may be adapted to any shape, including complex freeforms, that can be formed as part of a modeling process without adding cost to manufacturing. In addition, the athermal optical coupler assembly 100 may reshape the light beam from one aspect ratio to another without a need for additional elements, since the optical surfaces can be molded into any shape. For example, in a case where an aspect ratio of the optical source and the optical target are different, the athermal optical coupler assembly 100 may reshape the light beam from one aspect ratio to the other aspect ratio.

In some implementations, the light collector optical component 104 may collimate and shape the light beam to a desired aspect ratio (e.g., a desired ratio of beam width and beam height). The coupling optical component 106 may focus collimated light onto a target plane at the optical input of the receiving component 108. The light collector optical component 104 and the coupling optical component 106 may employ asymmetry to counteract beam divergence created by optical axis shift. Both the light collector optical component 104 and the coupling optical component 106 may change their respective positions with temperature. However, the coupling optical component 106 may be configured to redirect a light beam that departs from a desired optical axis back to a nominal image location (e.g., back to the desired target location). For example, the coupling optical component 106 may redirect the collected light beam 110 by converting the spatial offset into an angular offset to reduce or eliminate the beam divergence from the nominal image location. The focused light beam 128 may converge or substantially converge at the focal plane of the fourth optically reflective surface 124 despite changes in ambient temperature within the range predetermined temperature range. Thus, the athermal optical coupler assembly 100 may be insensitive or substantially insensitive to an acceptable range of temperature change to minimize changes in insertion loss at the optical input of the receiving component 108.

As an example, the disturbed beam path may diverge from the undisturbed beam path as the beam paths enter the coupling optical component 106. However, a geometry of the coupling optical component 106 may compensate for the divergence, and the two beam paths converge at the optical input of the receiving component 108. In some implementations, a geometry of the fourth optically reflective surface 124 may compensate for beam deviations caused within the predetermined temperature range such that all beams produced within the predetermined temperature range converge at the nominal image location. Thus, despite a beam divergence caused by a temperature shift, light beams are ultimately directed to a same target location with low insertion/coupling loss. The light propagation through the athermal optical coupler assembly 100 has been described in one direction. However, light propagation may also occur in a similar manner in an opposite direction. Thus, light may be first received by the coupling optical component 106 and transmitted from the coupling optical component 106 to the light collector optical component 104. In some implementations, the athermal optical coupler assembly 100 may be a bidirectional optical coupling system.

As indicated above, FIGS. 1A and 1B are provided as examples. Other examples may differ from what is described with regard to FIGS. 1A and 1B.

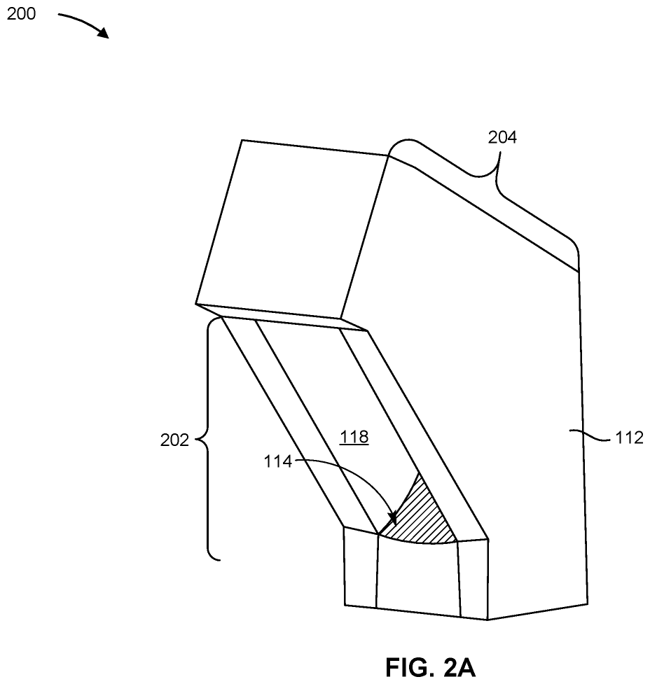

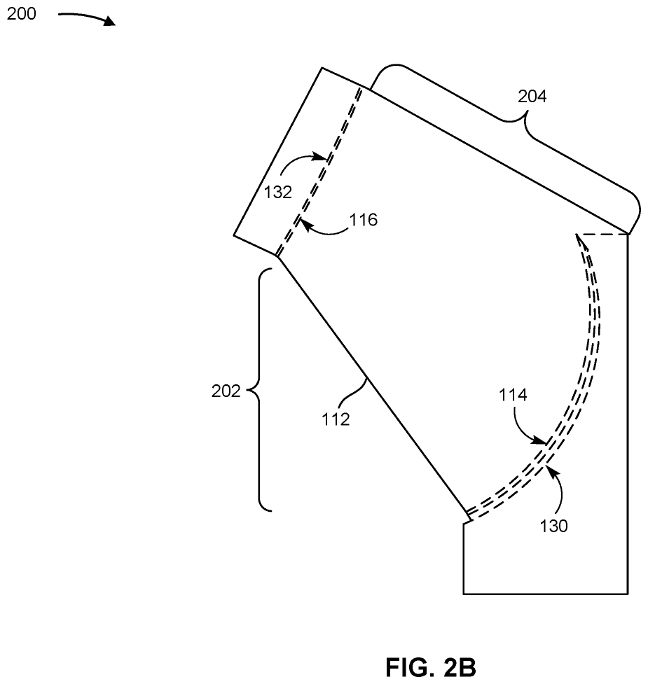

FIGS. 2A and 2B show a light collector optical component 200 according to one or more implementations. FIG. 2A shows a perspective view of the light collector optical component 200, whereas FIG. 2B shows a side view of the light collector optical component 200. The light collector optical component 200 may be similar to the light collector optical component 104 described in connection with FIGS. 1A and 1B. The light collector optical component 200 may be a one-piece molded plastic structure with two optically reflective surfaces. The first body 112 may define surfaces 130 and 132 on which the first optically reflective surface 114 and the second optically reflective surface 116 are formed, respectively. The first body 112 may define the first cavity 118 through which the light beam travels from the first optically reflective surface 114 to the second optically reflective surface 116. The light collector optical component 200 may include a first opening 202 for receiving light and a second opening 204 for outputting light. For example, the first opening 202 may be an input of the first cavity 118, and the second opening 204 may be an output of the first cavity 118. The first cavity 118 may be defined, at least in part, by sidewalls of the first body 112.

The coupling optical component 106, described in FIG. 1B, may be formed in a similar manner with molded plastic used to form a one-piece molded plastic structure. For example, the second body 120 of the optical component 106 may define surfaces 134 and 136, and may define the second cavity 126 through which the light beam travels from the third optically reflective surface 122 to the fourth optically reflective surface 124. The coupling optical component 106 may include a first opening for receiving light and a second opening for outputting light. As indicated above, FIGS. 2A and 2B are provided as examples. Other examples may differ from what is described with regard to FIGS. 2A and 2B.

The following provides an overview of some Aspects of the present disclosure:

Aspect 1: An athermal optical coupler assembly, comprising: a light collector optical component configured to receive a light beam and convert the light beam into a collected light beam; and a coupling optical component optically coupled to the light collector optical component, wherein the coupling optical component is configured to receive the collected light beam from the light collector optical component and focus the collected light beam onto a target area, wherein the light collector optical component includes a first body having a one-piece integral construction made of a first molded plastic, a first optically reflective surface arranged on the first body, and a second optically reflective surface arranged on the first body, wherein the coupling optical component includes a second body having a one-piece integral construction made of a second molded plastic, a third optically reflective surface arranged on the second body, and a fourth optically reflective surface arranged on the second body, wherein the second optically reflective surface is optically coupled between the first optically reflective surface and the third optically reflective surface, wherein the third optically reflective surface is optically coupled between the second optically reflective surface and the fourth optically reflective surface, and wherein the athermal optical coupler assembly is configured to maintain a projection of the collected light beam via the coupling optical component at the target area irrespective of an ambient temperature within a predetermined temperature range.

Aspect 2: The athermal optical coupler assembly of Aspect 1, wherein the coupling optical component is configured to focus a beam center of the collected light beam within a predetermined distance from a center of the target area irrespective of the ambient temperature within the predetermined temperature range.

Aspect 3: The athermal optical coupler assembly of any of Aspects 1-2, wherein the coupling optical component is configured to convert the collected light beam into a focused light beam that is focused onto the target area irrespective of the ambient temperature within the predetermined temperature range.

Aspect 4: The athermal optical coupler assembly of any of Aspects 1-3, wherein the target area is located at a focal plane of the fourth optically reflective surface.

Aspect 5: The athermal optical coupler assembly of any of Aspects 1-4, wherein the light collector optical component is optically coupled to an output of a transmitting optical component for receiving the light beam from the transmitting optical component, wherein the coupling optical component is optically coupled to an input of a receiving optical component, and wherein the input is arranged at the target area such that the collected light beam is coupled into the input.

Aspect 6: The athermal optical coupler assembly of Aspect 5, wherein the transmitting optical component comprises a first optical waveguide or a first optical fiber optically coupled to the light collector optical component for providing the light beam to the light collector optical component, and wherein the receiving optical component comprises a second optical waveguide or a second optical fiber coupled to and arranged at the input.

Aspect 7: The athermal optical coupler assembly of Aspect 6, wherein the light collector optical component is configured to reshape a cross-section of the light beam from a first beam profile into a second beam profile to conform to a cross-section of the second optical waveguide or the second optical fiber, and wherein the collected light beam has the second beam profile.

Aspect 8: The athermal optical coupler assembly of Aspect 6, wherein the coupling optical component is configured to reshape a cross-section of the collected light beam from a first beam profile into a second beam profile to conform to a cross-section of the second optical waveguide or the second optical fiber.

Aspect 9: The athermal optical coupler assembly of any of Aspects 1-8, wherein the light collector optical component is configured to reshape a cross-section of the light beam from a first beam profile into a second beam profile, and wherein the collected light beam has the second beam profile.

Aspect 10: The athermal optical coupler assembly of Aspect 9, wherein the first beam profile is an elliptical profile, and wherein the second beam profile is a circular profile.

Aspect 11: The athermal optical coupler assembly of Aspect 9, wherein the first beam profile has a first aspect ratio, and wherein the second beam profile has a second aspect ratio that is different from the first aspect ratio.

Aspect 12: The athermal optical coupler assembly of Aspect 9, wherein the light collector optical component is configured to convert the light beam into the collected light beam by rotating an axis of the light beam such that the collected light beam has a rotated axis relative to the light beam.

Aspect 13: The athermal optical coupler assembly of any of Aspects 1-12, wherein the coupling optical component is configured to convert a spatial offset of the collected light beam resultant from a temperature change of ambient temperature into an angular offset at the target area.

Aspect 14: The athermal optical coupler assembly of any of Aspects 1-13, wherein the fourth optically reflective surface is configured to convert a spatial offset resultant from a temperature change of ambient temperature into an angular offset at the target area such that the collected light beam is focused on the target area with the angular offset.

Aspect 15: The athermal optical coupler assembly of Aspect 14, wherein the spatial offset is a deviation from a nominal optical path between the light collector optical component and the coupling optical component.

Aspect 16: The athermal optical coupler assembly of any of Aspects 1-15, wherein the first body has a first concave surface, wherein the first optically reflective surface is arranged on the first concave surface and conforms to the first concave surface, wherein the first body has a convex surface, and wherein the second optically reflective surface is arranged on the convex surface and conforms to the convex surface.

Aspect 17: The athermal optical coupler assembly of Aspect 16, wherein the second body has a second concave surface, wherein the fourth optically reflective surface is arranged on the second concave surface and conforms to the second concave surface.

Aspect 18: The athermal optical coupler assembly of any of Aspects 1-17, wherein the second body has a flat surface, wherein the third optically reflective surface is arranged on the flat surface and conforms to the flat surface, wherein the second body has a parabolic surface, and wherein the fourth optically reflective surface is arranged on the parabolic surface and conforms to the parabolic surface.

Aspect 19: The athermal optical coupler assembly of any of Aspects 1-18, wherein the first optically reflective surface and the second optically reflective surface, in combination, produce no spherical aberrations.

Aspect 20: The athermal optical coupler assembly of any of Aspects 1-19, wherein the third optically reflective surface is configured to compensate for an aberration produced by the light collector optical component.

Aspect 21: The athermal optical coupler assembly of any of Aspects 1-20, wherein the first molded plastic is a first optical plastic, and wherein the second molded plastic is a second optical plastic.

Aspect 22: The athermal optical coupler assembly of any of Aspects 1-21, wherein the athermal optical coupler assembly is substantially insensitive to a temperature change of ambient temperature within the predetermined temperature range.

Aspect 23: A system configured to perform one or more operations recited in one or more of Aspects 1-22.

Aspect 24: An apparatus comprising means for performing one or more operations recited in one or more of Aspects 1-22.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An athermal optical coupler assembly, comprising:
a light collector optical component configured to receive a light beam and convert the light beam into a collected light beam; and
a coupling optical component optically coupled to the light collector optical component, wherein the coupling optical component is configured to receive the collected light beam from the light collector optical component and focus the collected light beam onto a target area,
wherein the light collector optical component includes a first body having a one-piece integral construction made of a first molded plastic, a first optically reflective surface arranged on the first body, and a second optically reflective surface arranged on the first body,
wherein the coupling optical component includes a second body having a one-piece integral construction made of a second molded plastic, a third optically reflective surface arranged on the second body, and a fourth optically reflective surface arranged on the second body,
wherein the second optically reflective surface is optically coupled between the first optically reflective surface and the third optically reflective surface,
wherein the third optically reflective surface is optically coupled between the second optically reflective surface and the fourth optically reflective surface, and
wherein the athermal optical coupler assembly is configured to maintain a projection of the collected light beam via the coupling optical component at the target area irrespective of an ambient temperature within a predetermined temperature range.

2. The athermal optical coupler assembly of claim 1, wherein the coupling optical component is configured to focus a beam center of the collected light beam within a predetermined distance from a center of the target area irrespective of the ambient temperature within the predetermined temperature range.

3. The athermal optical coupler assembly of claim 1, wherein the coupling optical component is configured to convert the collected light beam into a focused light beam that is focused onto the target area irrespective of the ambient temperature within the predetermined temperature range.

4. The athermal optical coupler assembly of claim 1, wherein the target area is located at a focal plane of the fourth optically reflective surface.

5. The athermal optical coupler assembly of claim 1, wherein the light collector optical component is optically coupled to an output of a transmitting optical component for receiving the light beam from the transmitting optical component,
wherein the coupling optical component is optically coupled to an input of a receiving optical component, and
wherein the input is arranged at the target area such that the collected light beam is coupled into the input.

6. The athermal optical coupler assembly of claim 5, wherein the transmitting optical component comprises a first optical waveguide or a first optical fiber optically coupled to the light collector optical component for providing the light beam to the light collector optical component, and
wherein the receiving optical component comprises a second optical waveguide or a second optical fiber coupled to and arranged at the input.

7. The athermal optical coupler assembly of claim 6, wherein the light collector optical component is configured to reshape a cross-section of the light beam from a first beam profile into a second beam profile to conform to a cross-section of the second optical waveguide or the second optical fiber, and
wherein the collected light beam has the second beam profile.

8. The athermal optical coupler assembly of claim 6, wherein the coupling optical component is configured to reshape a cross-section of the collected light beam from a first beam profile into a second beam profile to conform to a cross-section of the second optical waveguide or the second optical fiber.

9. The athermal optical coupler assembly of claim 1, wherein the light collector optical component is configured to reshape a cross-section of the light beam from a first beam profile into a second beam profile, and
wherein the collected light beam has the second beam profile.

10. The athermal optical coupler assembly of claim 9, wherein the first beam profile is an elliptical profile, and
wherein the second beam profile is a circular profile.

11. The athermal optical coupler assembly of claim 9, wherein the first beam profile has a first aspect ratio, and
wherein the second beam profile has a second aspect ratio that is different from the first aspect ratio.

12. The athermal optical coupler assembly of claim 9, wherein the light collector optical component is configured to convert the light beam into the collected light beam by rotating an axis of the light beam such that the collected light beam has a rotated axis relative to the light beam.

13. The athermal optical coupler assembly of claim 1, wherein the coupling optical component is configured to convert a spatial offset of the collected light beam resultant from a temperature change of ambient temperature into an angular offset at the target area.

14. The athermal optical coupler assembly of claim 1, wherein the fourth optically reflective surface is configured to convert a spatial offset resultant from a temperature change of ambient temperature into an angular offset at the target area such that the collected light beam is focused on the target area with the angular offset.

15. The athermal optical coupler assembly of claim 14, wherein the spatial offset is a deviation from a nominal optical path between the light collector optical component and the coupling optical component.

16. The athermal optical coupler assembly of claim 1, wherein the first body has a first concave surface,
wherein the first optically reflective surface is arranged on the first concave surface and conforms to the first concave surface,
wherein the first body has a convex surface, and
wherein the second optically reflective surface is arranged on the convex surface and conforms to the convex surface.

17. The athermal optical coupler assembly of claim 16, wherein the second body has a second concave surface,
wherein the fourth optically reflective surface is arranged on the second concave surface and conforms to the second concave surface.

18. The athermal optical coupler assembly of claim 1, wherein the second body has a flat surface,
wherein the third optically reflective surface is arranged on the flat surface and conforms to the flat surface,
wherein the second body has a parabolic surface, and
wherein the fourth optically reflective surface is arranged on the parabolic surface and conforms to the parabolic surface.

19. The athermal optical coupler assembly of claim 1, wherein the first optically reflective surface and the second optically reflective surface, in combination, produce no spherical aberrations.

20. The athermal optical coupler assembly of claim 1, wherein the third optically reflective surface is configured to compensate for an aberration produced by the light collector optical component.

21. The athermal optical coupler assembly of claim 1, wherein the first molded plastic is a first optical plastic, and
wherein the second molded plastic is a second optical plastic.

22. The athermal optical coupler assembly of claim 1, wherein the athermal optical coupler assembly is substantially insensitive to a temperature change of ambient temperature within the predetermined temperature range.
